(19) United States
(12) Patent Application Publication
(10) Pub. No.: US 2025/0117647 A1
(43) Pub. Date: Apr. 10, 2025

(54) Dynamic Exponent Bias Method for Neural Network Training

(71) Applicant: SambaNova Systems, Inc., Palo Alto, CA (US)

(72) Inventors: Valentina Popescu, San Diego, CA (US); Jeffrey S. Brooks, Austin, TX (US); Ram SIVARAMAKRISHNAN, San Jose, CA (US); Matthew William Ashcraft, San Carlos, CA (US); Vinh Quang Nguyen, San Diego, CA (US); Gang Liu, Palo Alto, CA (US); Raghu PRABHAKAR, San Jose, CA (US); Yongning SHENG, San Jose, CA (US)

(73) Assignee: SambaNova Systems, Inc., Palo Alto, CA (US)

(21) Appl. No.: 18/481,422

(22) Filed: Oct. 5, 2023

(51) Int. Cl. G06N 3/08

(52) U.S. Cl. CPC G06N 3/08

(57) ABSTRACT

A method that may be computer implemented converts a tensor value from a first format to a second format and trains a neural network. The method determines a maximum exponent code in the first format and subtracts a first bias to obtain the highest needed exponent. It determines a second bias from the highest available code (HAC) in the second format and the HNE, and converts the tensor value from the first format to the second format by using the second bias instead of the first bias. The method uses the second format to train the neural network. The method may round the mantissa of the tensor value in the first format to obtain a rounded mantissa of the tensor value for the second format.

### BACKGROUND

### Technical Field

The disclosed implementations relate generally to methods used in training neural networks in machine learning applications.

### CONTEXT

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Industry trends show that neural networks are getting bigger fast. This makes them more expensive to train, both in terms of energy, and time to converge. One of the methods employed for reducing cost is quantization, i.e., the use of lower or mixed-precision data. However, keeping accuracy in low-precision training can be challenging and requires careful handling of tensor values and representation range. For this reason, conventional neural networks use data that has a precision of at least IEEE 754 fp16, a 16-bit floating-point format, or bf16, a 16-bit floating-point format developed by Google.

### SUMMARY

The technology disclosed relates to methods used in training neural networks in machine learning applications.

In some aspects, the techniques described herein relate to a method of converting a tensor value to train a neural network, including: determining a maximum exponent code used in the tensor, based on a first format with a first bias; subtracting the first bias from the maximum exponent code to obtain a highest needed exponent (HNE); determining a second bias from a highest available code (HAC) in a second format and the HNE; converting a tensor value from the first format to the second format by using the second bias instead of the first bias; and using the tensor value in the second format to train the neural network.

In some aspects, the techniques described herein relate to a non-transitory computer-readable storage medium storing computer program instructions to convert a tensor value to train a neural network, wherein the computer program instructions, when executed on a processor, implement actions including: determine a maximum exponent code used in the tensor, based on a first format with a first bias; subtract the first bias from the maximum exponent code to obtain a highest needed exponent (HNE); determine a second bias from a highest available code (HAC) in a second format and the HNE; convert a tensor value from the first format to the second format by using the second bias instead of the first bias; and use the tensor value in the second format to train the neural network.

In some aspects, the techniques described herein relate to a system including one or more processors coupled to a memory, the memory loaded with computer program instructions to convert a tensor value to train a neural network, wherein the computer program instructions, when executed on the one or more processors, implement actions including: determine a maximum exponent code used in the tensor, based on a first format with a first bias; subtract the first bias from the maximum exponent code to obtain a highest needed exponent (HNE); determine a second bias from a highest available code (HAC) in a second format and the HNE; convert a tensor value from the first format to the second format by using the second bias instead of the first bias; and use the tensor value in the second format to train the neural network.

A further understanding of the nature and the advantages of particular implementations disclosed herein may be realized by reference of the remaining portions of the specification and the attached drawings.

### BRIEF DESCRIPTION OF THE DRAWINGS

The technology will be described with reference to the drawings, in which:

FIG. 1 illustrates an example system including a coarse-grained reconfigurable (CGR) processor, a host, and a memory.

FIG. 2 illustrates an example of a computer, including an input device, a processor, a storage device, and an output device.

FIG. 3 illustrates example details of a CGR architecture including a top-level network (TLN) and two CGR arrays.

FIG. 4 illustrates an example CGR array, including an array of CGR units in an array-level network (ALN).

FIG. 5 illustrates an example of a pattern memory unit (PMU) and a pattern compute unit (PCU), which may be combined in a fused compute and memory unit (FCMU).

FIG. 6 is a block diagram of a compiler stack implementation suitable for generating a configuration file for a CGR processor.

FIG. 7 shows an example user program in an example first stage of the compiler stack.

FIG. 8 shows the user program in an example second stage of the compiler stack.

FIG. 9 illustrates how a tensor can be converted from a high-resolution format to a low-resolution format for training a neural network, in an implementation of the disclosed technology.

FIG. 10 shows an example method of converting a tensor value to train a neural network.

FIG. 11 illustrates example details of converting a tensor value from the first format to the second format.

In the figures, like reference numbers may indicate functionally similar elements. The systems and methods illustrated in the figures—and described in the Detailed Description below—may be arranged and designed in a wide variety of different implementations. Neither the figures nor the Detailed Description are intended to limit the scope as claimed. Instead, they merely represent examples of different implementations.

### DETAILED DESCRIPTION

Traditional compilers translate human-readable computer source code into machine code that can be executed on a Von Neumann computer architecture. In this architecture, a processor serially executes instructions in one or more threads of software code. The architecture is static, and the compiler does not determine how execution of the instructions is pipelined, or which processor or memory takes care of which thread. Thread execution is asynchronous, and safe exchange of data between parallel threads is not supported.

High-level programs for machine learning (ML) and artificial intelligence (AI) may require massively parallel computations, where many parallel and interdependent threads (metapipelines) exchange data. Such programs are ill-suited for execution on Von Neumann computers. They require architectures that are optimized for parallel processing, such as coarse-grained reconfigurable (CGR) architectures (CGRAs) or graphic processing units (GPUs). The ascent of ML, AI, and massively parallel architectures places new requirements on compilers, including how computation graphs, and in particular dataflow graphs, are pipelined, which operations are assigned to which compute units, how data is routed between various compute units and memory, and how synchronization is controlled particularly when a dataflow graph includes one or more nested loops, whose execution time varies dependent on the data being processed.

Industry trends show that neural networks are getting bigger fast. This makes them more expensive to train, both in terms of energy, and time to converge. One of the methods employed for reducing cost is quantization, i.e., the use of lower or mixed-precision data. However, keeping accuracy in low-precision training can be challenging and requires careful handling of tensor values and representation range. For this reason, conventional neural networks use data that has a precision of at least IEEE 754 fp32, a 32-bit floating-point format, or bf16, a 16-bit floating-point format developed by Google. Both fp32 and bf16 have an 8-bit exponent, whose value ranges from 1 to 254 (0 and 255 have special meanings). The exponent is unsigned to allow for easy comparison between two numbers. However, to allow working with data of both very small and very large values, the exponent may be offset by a bias, for example 127. The bias may be fixed at a different value to shift the exponent range to a range that has been previously determined from the data.

Implementations of the technology developed herein can work with lower-precision training data, for example in an 8-bit floating point format such as 1-4-3 (sign-exponent-fraction bits) or 1-5-2. To achieve this, the technology disclosed uses a dynamic bias rather than a fixed bias. This document teaches a method to convert tensor values from a higher-resolution format to a lower-resolution format while dynamically changing the bias to optimally use the fraction bits provided in the format. This reduces power consumption and convergence time. No preprocessing steps are needed to pre-determine bias values. Compared to conventional methods such as using a static bias or scaling, a high accuracy can be achieved with low overhead.

### Terminology

As used herein, the phrase one of should be interpreted to mean exactly one of the listed items. For example, the phrase one of A, B, and C should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms comprising and consisting have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term coupled is used in an operational sense and is not limited to a direct or an indirect coupling. Coupled to is generally used in the sense of directly coupled, whereas coupled with is generally used in the sense of directly or indirectly coupled. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term connected is used to indicate a direct connection, such as electrical, optical, electromagnetic, or mechanical, between the things that are connected, without any intervening things or devices.

The term configured to perform a task or tasks is a broad recitation of structure generally meaning having circuitry that performs the task or tasks during operation. As such, the described item can be configured to perform the task even when the unit/circuit/component is not currently on or active. In general, the circuitry that forms the structure corresponding to configured to may include hardware circuits, and may further be controlled by switches, fuses, bond wires, metal masks, firmware, and/or software. Similarly, various items may be described as performing a task or tasks, for convenience in the description. Such descriptions should be interpreted as including the phrase configured to.

As used herein, the term based on is used to describe one or more factors that affect a determination. This term does not foreclose the possibility that additional factors may affect the determination. That is, a determination may be solely based on specified factors or based on the specified factors as well as other, unspecified factors. Consider the phrase determine A based on B. This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase based on is thus synonymous with the phrase based at least in part on.

The terms substantially, close, approximately, near, and about refer to being within minus or plus 10% of an indicated value, unless explicitly specified otherwise.

The following terms or acronyms used herein are defined at least in part as follows:

AGCU—address generator (AG) and coalescing unit (CU).

AI—artificial intelligence.

AIR—arithmetic or algebraic intermediate representation.

ALN—array-level network.

bf16—also known as BFLOAT16 or Brain Floating-Point Format—a floating-point format developed by Google with deep-learning applications in mind. bf16 has 16 bits, including one bit for a sign, eight bits for the exponent, and seven bits for the fraction. An implicit leading bit exists to the left of the implied binary point. bf16 can be seen as a rounded or truncated form of the IEEE 754 fp32 format.

Buffer—an intermediate storage of data.

CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.

CGRA—coarse-grained reconfigurable architecture. A data processor architecture that includes one or more arrays (CGR arrays) of CGR units.

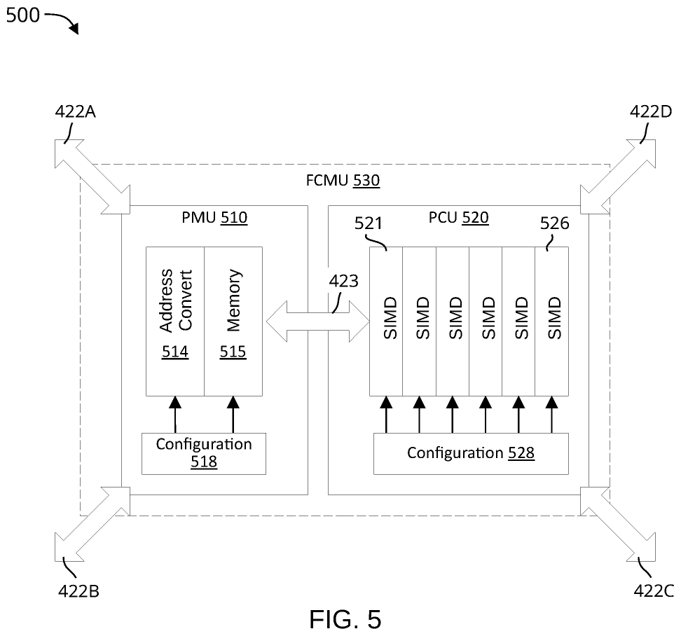

Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 5.

Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.

CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.

CU—coalescing unit.

Dataflow Graph—a computation graph that includes one or more loops that may be nested, and wherein nodes can send messages to nodes in earlier layers to control the dataflow between the layers.

Datapath—a collection of functional units that perform data processing operations. The functional units may include memory, multiplexers, ALUs, SIMDs, multipliers, registers, buses, etc.

FCMU—fused compute and memory unit—a circuit that includes both a memory unit and a compute unit.

fp8—a floating-point format with 8 bits, which may include one bit for a sign, several bits for an exponent, and the remaining bits for a fraction. For example, an fp8 format may include one bit for the sign, four bits for the exponent, and three bits for the fraction (denoted as 1-4-3) or one bit for the sign, five bits for the exponent, and 2 bits for the fraction (denoted as 1-5-2). An implicit leading bit may exist to the left of the implied binary point.

fp16—a floating-point format, for example as defined by IEEE 754. fp16 may have 16 bits, including one bit for the sign, five bits for the exponent, and 10 bits for a fraction. An implicit leading bit may exist to the left of the implied binary point.

fp32—a floating-point format, for example as defined by IEEE 754 and supported in TensorFlow (as tf.float32)/PyTorch (as torch.float32 or torch.float). fp32 may have 32 bits, including one bit for the sign, eight bits for the exponent, and 23 bits for a fraction. An implicit leading bit may exist to the left of the implied binary point.

Graph—a collection of nodes connected by edges. Nodes may represent various kinds of items or operations, dependent on the type of graph. Edges may represent relationships, directions, dependencies, etc.

IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.

A logical CGR array or logical CGR unit—a CGR array or a CGR unit that is physically realizable, but that may not have been assigned to a physical CGR array or to a physical CGR unit on an IC.

Metapipeline—a subgraph of a computation graph that includes a producer operator providing its output as an input to a consumer operator to form a pipeline. A metapipelines may be nested within another metapipeline, that is, producer operators and consumer operators may include other metapipelines.

ML—machine learning.

PCU—pattern compute unit—a compute unit that can be configured to repetitively perform a sequence of operations.

PEF—processor-executable format—a file format suitable for configuring a configurable data processor.

Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the CGR processor, CGR array level, and/or GCR unit level.

Pipeline Stages—a pipeline is divided into stages that are coupled with one another to form a pipe topology.

PMU—pattern memory unit—a memory unit that can locally store data according to a programmed pattern.

PNR—place and route—the assignment of logical CGR units and associated processing/operations to physical CGR units in an array, and the configuration of communication paths between the physical CGR units.

RAIL—reconfigurable dataflow unit (RDU) abstract intermediate language.

CGR Array—an array of CGR units, coupled with each other through an array-level network (ALN), and coupled with external elements via a top-level network (TLN). A CGR array can physically implement the nodes and edges of a dataflow graph.

SIMD—single-instruction multiple-data—an arithmetic logic unit (ALU) that simultaneously performs a single programmable operation on multiple data elements delivering multiple output results.

TLIR—template library intermediate representation.

TLN—top-level network.

### IMPLEMENTATIONS

The architecture, configurability and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

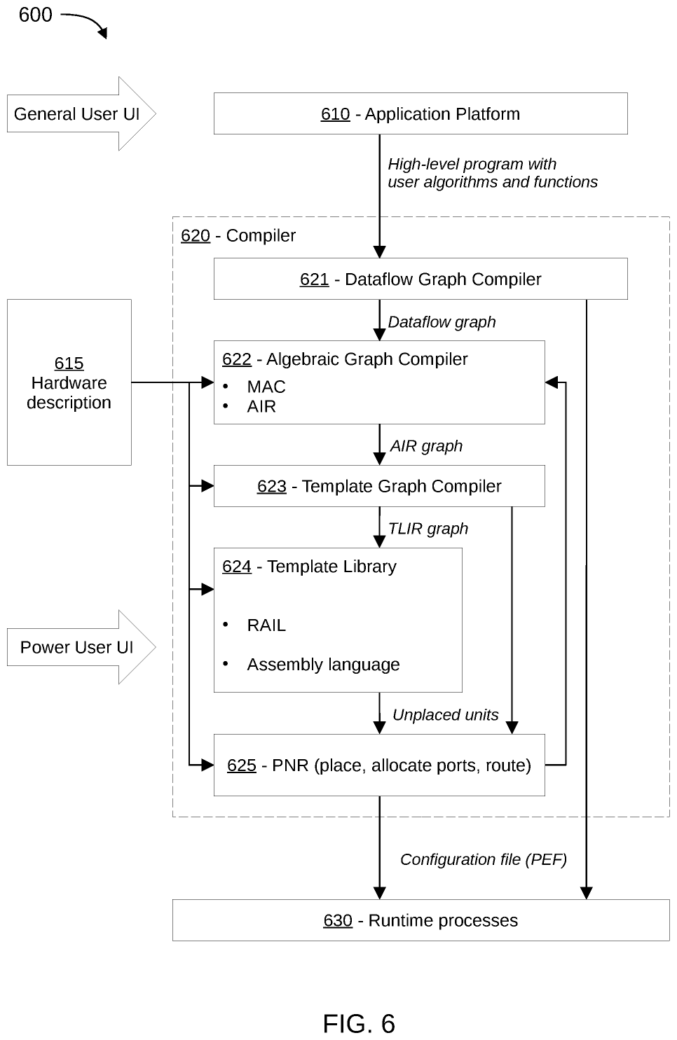

Translation of high-level programs to executable bit files is performed by a compiler, see, for example, FIGS. 6-11. While traditional compilers sequentially map operations to processor instructions, typically without regard to pipeline utilization and duration (a task usually handled by the hardware), an array of CGR units requires mapping operations to processor instructions in both space (for parallelism) and time (for synchronization of interdependent computation graphs or dataflow graphs). This requirement implies that a compiler for a CGRA must decide which operation of a computation graph or dataflow graph is assigned to which of the CGR units, and how both data and, related to the support of dataflow graphs, control information flows among CGR units, and to and from external hosts and storage. This process, known as “place and route”, is one of many new challenges posed to compilers for arrays of CGR units.

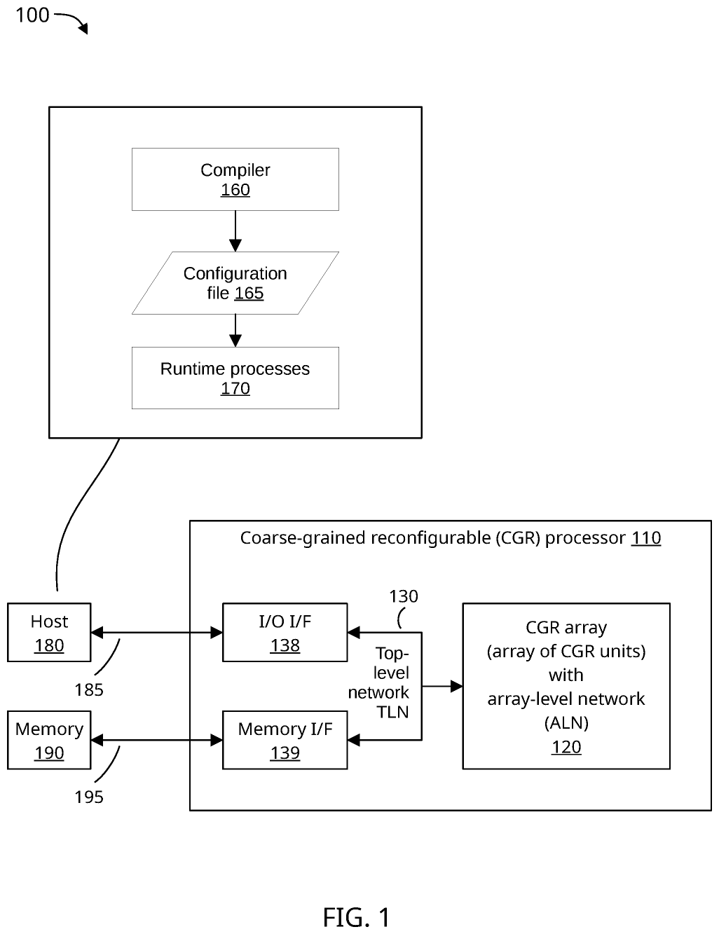

FIG. 1 illustrates an example system 100 including a CGR processor 110, a host 180, and a memory 190. CGR processor 110 has a coarse-grained reconfigurable architecture (CGRA) and includes an array of CGR units 120 such as a CGR array. CGR processor 110 further includes an IO interface 138, and a memory interface 139. Array of CGR units 120 is coupled with IO interface 138 and memory interface 139 via data bus 130 which may be part of a top-level network (TLN). Host 180 communicates with IO interface 138 via system data bus 185, and memory interface 139 communicates with memory 190 via memory bus 195. Array of CGR units 120 may further include compute units and memory units that are connected with an array-level network (ALN) to provide the circuitry for execution of a computation graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of CGR processor 110. In some implementations, CGR processor 110 may include one or more ICs. In other implementations, a single IC may span multiple CGR processors. In further implementations, CGR processor 110 may include one or more units of array of CGR units 120.

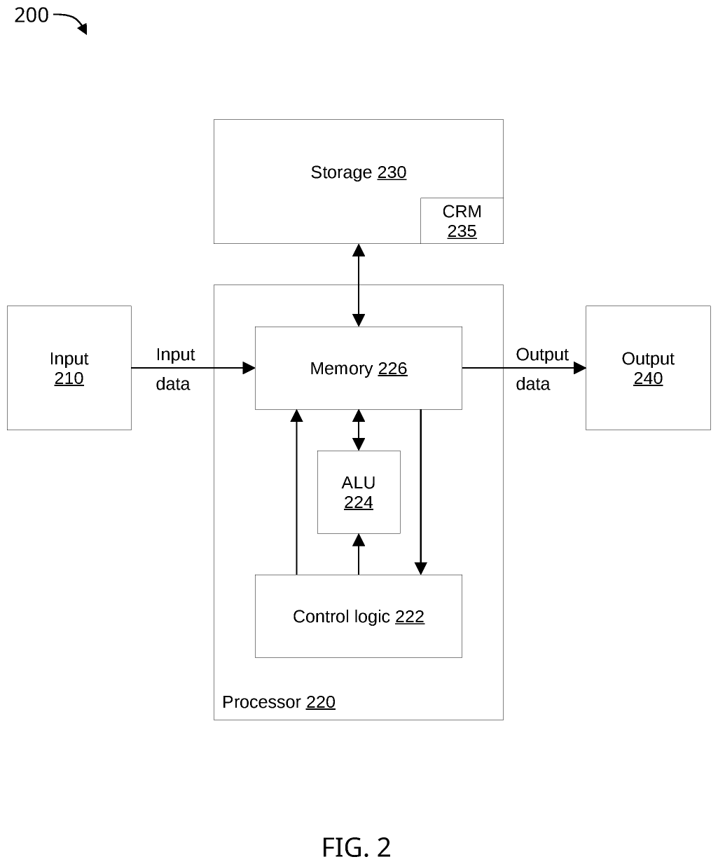

Host 180 may be, or include, a computer such as further described with reference to FIG. 2. Host 180 runs runtime processes, as further referenced herein, and may also be used to run computer programs, such as the compiler 160 further described herein with reference to FIG. 6. In some implementations, the compiler may run on a computer that is similar to the computer described with reference to FIG. 2, but separate from host 180.

CGR processor 110 may accomplish computational tasks by executing a configuration file 165 (for example, a PEF file). For the purposes of this description, a configuration file corresponds to a dataflow graph, or a translation of a dataflow graph, and may further include initialization data. A compiler 160 compiles the high-level program to provide the configuration file 165. Runtime processes 170 may install the configuration file 165 in CGR processor 110. In some implementations described herein, a CGR array is configured by programming one or more configuration stores with all or parts of the configuration file 165. A single configuration store may be at the level of the CGR processor 110 or the CGR array 120, or a CGR unit may include an individual configuration store. The configuration file 165 may include configuration data for the CGR array 120 and CGR units in the CGR array 120, and link the computation graph to the CGR array 120. Execution of the configuration file by CGR processor 110 causes the CGR array 120 to implement the user algorithms and functions in the dataflow graph.

CGR processor 110 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 2 illustrates an example of a computer 200, including an input device 210, a processor 220, a storage device 230, and an output device 240. Although the example computer 200 is drawn with a single processor, other implementations may have multiple processors. Input device 210 may comprise a mouse, a keyboard, a sensor, an input port (for example, a universal serial bus (USB) port), and any other input device known in the art. Output device 240 may comprise a monitor, printer, and any other output device known in the art. Furthermore, part or all of input device 210 and output device 240 may be combined in a network interface, such as a Peripheral Component Interconnect Express (PCIe) interface suitable for communicating with CGR processor 110. Input device 210 is coupled with processor 220 to provide input data, which an implementation may store in memory 226. Processor 220 is coupled with output device 240 to provide output data from memory 226 to output device 240. Processor 220 further includes control logic 222, operable to control memory 226 and arithmetic and logic unit (ALU) 224, and to receive program and configuration data from memory 226. Control logic 222 further controls exchange of data between memory 226 and storage device 230. Memory 226 typically comprises memory with fast access, such as static random-access memory (SRAM), whereas storage device 230 typically comprises memory with slow access, such as dynamic random-access memory (DRAM), flash memory, magnetic disks, optical disks, and any other memory type known in the art. At least a part of the memory in storage device 230 includes a non-transitory computer-readable medium (CRM 235), such as used for storing computer programs.

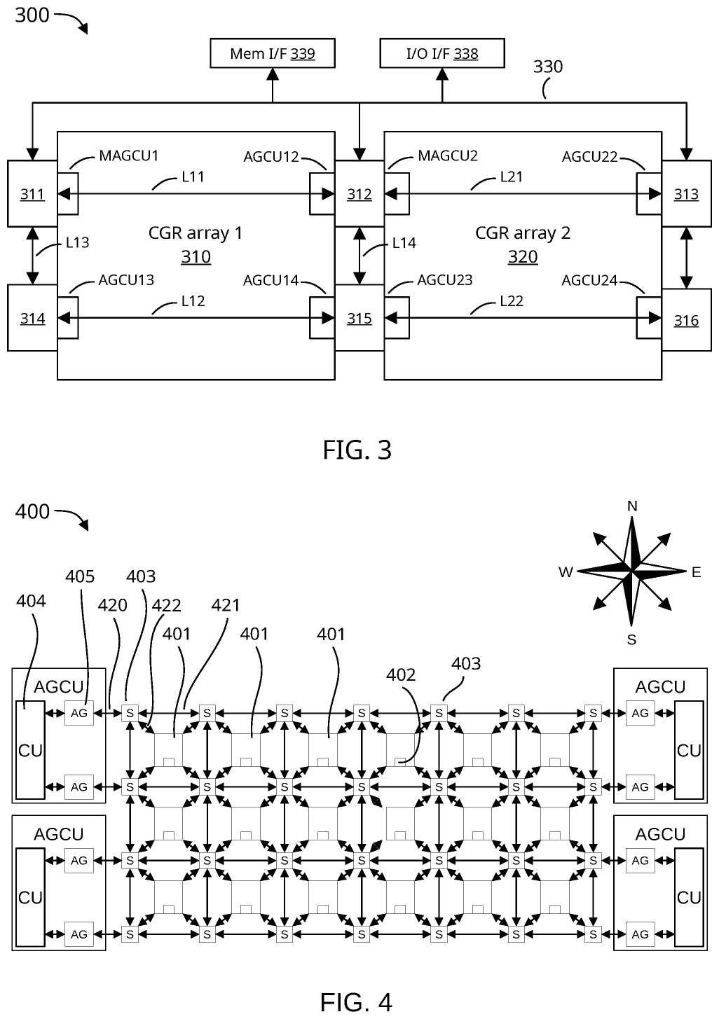

FIG. 3 illustrates example details of a CGR architecture 300 including a top-level network (TLN 330) and two CGR arrays (CGR array 310 and CGR array 320). A CGR array comprises an array of CGR units (e.g., PMUs, PCUs, FCMUs) coupled via an array-level network (ALN), e.g., a bus system. The ALN is coupled with the TLN 330 through several AGCUs, and consequently with I/O interface 338 (or any number of interfaces) and memory interface 339. Other implementations may use different bus or communication architectures.

Circuits on the TLN in this example include one or more external I/O interfaces, including I/O interface 338 and memory interface 339. The interfaces to external devices include circuits for routing data among circuits coupled with the TLN and external devices, such as high-capacity memory, host processors, other CGR processors, FPGA devices, and so on, that are coupled with the interfaces.

Each depicted CGR array has four AGCUs (e.g., MAGCU1, AGCU12, AGCU13, and AGCU14 in CGR array 310). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 310, and MAGCU2 includes a configuration load/unload controller for CGR array 320. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 311, switch 312, switch 313, switch 314, switch 315, and switch 316) coupled with each other as well as with other circuits on the TLN, including the AGCUs, and external I/O interface 338. The TLN includes links (e.g., L11, L12, L21, L22) coupling the top-level switches. Data may travel in packets between the top-level switches on the links, and from the switches to the circuits on the network coupled with the switches. For example, switch 311 and switch 312 are coupled by link L11, switch 314 and switch 315 are coupled by link L12, switch 311 and switch 314 are coupled by link L13, and switch 312 and switch 313 are coupled by link L21. The links can include one or more buses and supporting control lines, including for example a chunk-wide bus (vector bus). For example, the top-level network can include data, request and response channels operable in coordination for transfer of data in any manner known in the art.

FIG. 4 illustrates an example CGR array 400, including an array of CGR units in an ALN. CGR array 400 may include several types of CGR unit 401, such as FCMUs, PMUs, PCUs, memory units, compute units, AGCUs, and/or switches. For examples of the functions of these types of CGR units, see Prabhakar et al., “Plasticine: A Reconfigurable Architecture for Parallel Patterns”, ISCA 2017 Jun. 24-28, 2017, Toronto, ON, Canada. Each of the CGR units may include a configuration store 402 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 401 comprises an FCMU. In other implementations, the array comprises both PMUs and PCUs, or memory units and compute units, arranged in a checkerboard pattern. In yet other implementations, CGR units may be arranged in different patterns. The ALN includes switch units 403 (S), and AGCUs (each including two address generators 405 (AG) and a shared coalescing unit 404 (CU)). Switch units 403 are connected among themselves via interconnects 421 and to a CGR unit 401 with interconnects 422. Switch units 403 may be coupled with address generators 405 via interconnects 420. In some implementations, communication channels can be configured as end-to-end connections, and switch units 403 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 421 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

A CGR unit 401 may have four ports (as drawn) to interface with switch units 403, or any other number of ports suitable for an ALN. Each port may be suitable for receiving and transmitting data, or a port may be suitable for only receiving or only transmitting data.

A switch unit, as shown in the example of FIG. 4, may have eight interfaces. The North, South, East and West interfaces of a switch unit may be used for links between switch units using interconnects 421. The Northeast, Southeast, Northwest and Southwest interfaces of a switch unit may each be used to make a link with an FCMU, PCU or PMU instance using one of the interconnects 422. Two switch units in each CGR array quadrant have links to an AGCU using interconnects 420. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more links between the switch units to the CGR units using the vector bus and vector interface(s) of the one or more switch units on the ALN. A CGR array may comprise at least a part of CGR array 400, and any number of other CGR arrays coupled with CGR array 400.

A data processing operation implemented by CGR array configuration may comprise multiple graphs or subgraphs specifying data processing operations that are distributed among and executed by corresponding CGR units (e.g., FCMUs, PMUs, PCUs, AGs, and CUs).

FIG. 5 illustrates an example 500 of a PMU 510 and a PCU 520, which may be combined in an FCMU 530. PMU 510 may be directly coupled to PCU 520, or optionally via one or more ALN links 423, or optionally via links through one or more switches. The FCMU 530 may include multiple ALN links, such as northwest ALN link 422A and southwest ALN link 422B, which may connect to PMU 510, and southeast ALN link 422C and northeast ALN link 422D, which may connect to PCU 520. The northwest ALN link 422A, southwest ALN link 422B, southeast ALN link 422C, and northeast ALN link 422D connect to switches 403 as shown in FIG. 4. Each ALN link 422A-D, 423 may include one or more scalar links, one or more vector links, and one or more control links where an individual link may be unidirectional into FCMU 530, unidirectional out of FCMU 530 or bidirectional. FCMU 530 can include FIFOs to buffer data entering and/or leaving the FCMU 530 on the links.

PMU 510 may include an address converter 514, a scratchpad memory 515, and a configuration store 518. Configuration store 518 may be loaded, for example, from a program running on host 180 as shown in FIG. 1, and can configure address converter 514 to generate or convert address information for scratchpad memory 515 based on data received through one or more of the ALN links 422A-B, and/or 423. Data received through ALN links 422A-B, and/or 423 may be written into scratchpad memory 515 at addresses provided by address converter 514. Data read from scratchpad memory 515 at addresses provided by address converter 514 may be sent out on one or more of the ALN links 422A-B, and/or 423.

PCU 520 includes two or more processor stages, such as SIMD 521 through SIMD 526, and configuration store 528. The processor stages may include ALUs, or SIMDs, as drawn, or any other reconfigurable stages that can process data. PCU 520 may receive data through ALN links 422C-D, and/or 423, and process the data in the two or more processor stages or store the data in configuration store 528. PCU 520 may produce data in the two or more processor stages, and transmit the produced data through one or more of the ALN links 422C-D, and/or 423. If the two or more processor stages include SIMDs, then the SIMDs may have a number of lands of processing equal to the number of lanes of data provided by a vector interconnect of ALN links 422C-D, and/or 423.

Each stage in PCU 520 may also hold one or more registers (not drawn) for short-term storage of parameters. Short-term storage, for example during one to several clock cycles or unit delays, allows for synchronization of data in the PCU pipeline.

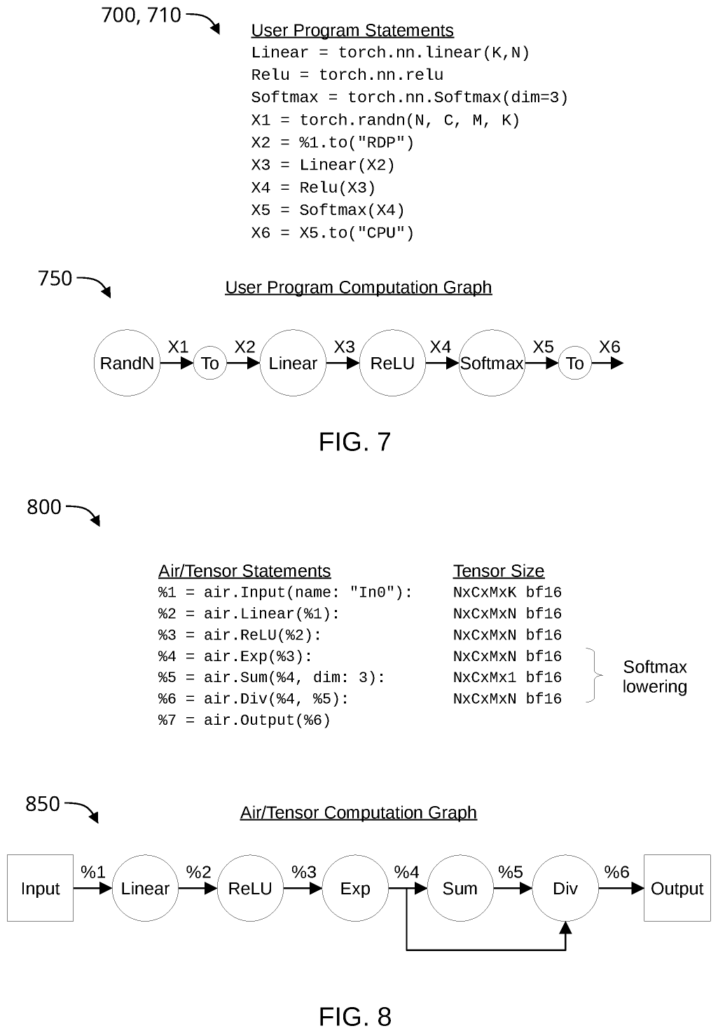

FIG. 6 is a block diagram of a compiler stack 600 implementation suitable for generating a configuration file for a CGR processor. FIGS. 7-11 illustrate various representations of an example user program 700 corresponding to various stages of a compiler stack such as compiler stack 600. As depicted, compiler stack 600 includes several stages to convert a high-level program (e.g., user program 700) with statements 710 that define user algorithms and functions, e.g., algebraic expressions and functions, to configuration data for the CGR units. The example user program 700 depicted in FIG. 7 comprises statements 710 that invoke various PyTorch functions.

Compiler stack 600 may take its input from application platform 610, or any other source of high-level program statements suitable for parallel processing, which provides a user interface for general users. It may further receive hardware description 615, for example defining the physical units in a reconfigurable data processor or CGRA processor. Application platform 610 may include libraries such as PyTorch, TensorFlow, ONNX, Caffe, and Keras to provide user-selected and configured algorithms.

Application platform 610 outputs a high-level program to compiler 620, which in turn outputs a configuration file to the reconfigurable data processor or CGRA processor where it is executed in runtime processes 630. Compiler 620 may include dataflow graph compiler 621, which may handle a dataflow graph, algebraic graph compiler 622, template graph compiler 623, template library 624, and placer and router PNR 625. In some implementations, template library 624 includes RDU abstract intermediate language (RAIL) and/or assembly language interfaces for power users.

Dataflow graph compiler 621 converts the high-level program with user algorithms and functions from application platform 610 to one or more dataflow graphs. The high-level program may be suitable for parallel processing, and therefore parts of the nodes of the dataflow graphs may be intrinsically parallel unless an edge in the graph indicates a dependency. Dataflow graph compiler 621 may provide code optimization steps like false data dependency elimination, dead-code elimination, and constant folding. The dataflow graphs encode the data and control dependencies of the high-level program. Dataflow graph compiler 621 may support programming a reconfigurable data processor at higher or lower-level programming languages, for example from an application platform 610 to C++ and assembly language. In some implementations, dataflow graph compiler 621 allows programmers to provide code that runs directly on the reconfigurable data processor. In other implementations, dataflow graph compiler 621 provides one or more libraries that include predefined functions like linear algebra operations, element-wise tensor operations, non-linearities, and reductions required for creating, executing, and profiling the dataflow graphs on the reconfigurable processors. Dataflow graph compiler 621 may provide an application programming interface (API) to enhance functionality available via the application platform 610.

FIG. 7 shows an example user program 700 in an example first stage of the compiler stack. User program 700 generates a random tensor X1 with a normal distribution in the RandN node. It provides the tensor to a neural network cell that performs a weighing function (in the Linear node) followed by a rectified linear unit (ReLU) activation function, which is followed by a Softmax activation function, for example to normalize the output to a probability distribution over a predicted output class. FIG. 7 does not show the weights and bias used for the weighing function. User program 700 corresponds with computation graph 750.

Algebraic graph compiler 622 may include a model analyzer and compiler (MAC) level that makes high-level mapping decisions for (sub-graphs of the) dataflow graph based on hardware constraints. It may support various application frontends such as Samba, JAX, and TensorFlow/HLO. Algebraic graph compiler 622 may also transform the graphs via autodiff and GradNorm, perform stitching between sub-graphs, interface with template generators for performance and latency estimation, convert dataflow graph operations to AIR operation, perform tiling, sharding (database partitioning) and other operations, and model or estimate the parallelism that can be achieved on the dataflow graphs.

Algebraic graph compiler 622 may further include an arithmetic or algebraic intermediate representation (AIR) level that translates high-level graph and mapping decisions provided by the MAC level into explicit AIR/Tensor statements 800 (see FIG. 8) and one or more corresponding algebraic graphs 850. Key responsibilities of the AIR level include legalizing the graph and mapping decisions of the MAC, expanding data parallel, tiling, metapipe, region instructions provided by the MAC, inserting stage buffers and skip buffers, eliminating redundant operations, buffers and sections, and optimizing for resource use, latency, and throughput.

FIG. 8 shows the user program 700 in an example second stage of the compiler stack. At this stage, the algebraic graph compiler replaces the Softmax macro by its constituents. The Softmax function is given as:

$$\frac{{e}^{\{ {z}_{i} \}}}{{Σ}_{\text{?}}^{K} {e}^{\{ {z}_{j} \}}} .$$

$$\text{?} \text{indicates text missing or illegible when filed}$$

This function includes an exponential component, a summation, and a division. Thus, algebraic graph compiler 622 replaces the user program statements 710, also shown as computation graph 750, by AIR/Tensor statements 800, also shown as Air/Tensor computation graph 850.

A first example of accelerated deep learning is using a deep learning accelerator implemented in a CGRA to train a neural network. A second example of accelerated deep learning is using the deep learning accelerator to operate a trained neural network to perform inferences. A third example of accelerated deep learning is using the deep learning accelerator to train a neural network and subsequently perform inference with any one or more of the trained neural network, information from the trained neural network, and a variant of the same.

Examples of neural networks include fully connected neural networks (FCNNs), recurrent neural networks (RNNs), graph neural networks (GNNs), convolutional neural networks (CNNs), graph convolutional networks (GCNs), long short-term memory (LSTM) networks, autoencoders, deep belief networks, and generative adversarial networks (GANs).

An example of training a neural network is determining one or more weights associated with the neural network, such as by back-propagation in a deep learning accelerator. An example of making an inference is using a trained neural network to compute results by processing input data using the weights associated with the trained neural network. As used herein, the term ‘weight’ is an example of a ‘parameter’ as used in various forms of neural network processing. For example, some neural network learning is directed to determining parameters (e.g., through back-propagation) that are usable for performing neural network inferences.

A neural network processes data according to a dataflow graph comprising layers of neurons. Example layers of neurons include input layers, hidden layers, and output layers. Stimuli (e.g., input data) are received by an input layer of neurons and the computed results of the dataflow graph (e.g., output data) are provided by an output layer of neurons. Example hidden layers include rectified linear unit (ReLU) layers, fully connected layers, recurrent layers, graphical network layers, long short-term memory layers, convolutional layers, kernel layers, dropout layers, and pooling layers. A neural network may be conditionally and/or selectively trained. After being trained, a neural network may be conditionally and/or selectively used for inference.

Examples of ICs, or parts of ICs, that may be used as deep learning accelerators, are processors such as central processing unit (CPUs), CGR processor ICs, graphics processing units (GPUs), FPGAs, ASICS, application-specific instruction-set processor (ASIP), and digital signal processors (DSPs). The disclosed technology implements efficient distributed computing by allowing an array of accelerators (e.g., reconfigurable processors) attached to separate hosts to directly communicate with each other via buffers.

Recent industry trends show that neural networks are getting exponentially bigger. This also makes them more expensive to train, both in terms of energy, and time to convergence. One of the methods employed for reducing cost is quantization, i.e., the use of lower or mixed-precision data. However, keeping accuracy in low-precision training can be challenging and requires careful handling of tensor values and representation range. For this reason, conventional neural networks use data that has a precision of at least IEEE 754 fp32, a 32-bit floating-point format, or bf16, a 16-bit floating-point format developed by Google. Both fp32 and bf16 have an 8-bit exponent, whose value ranges from 1 to 254 (0 and 255 have special meanings). The exponent is 1-based to allow for easy comparison between two numbers. However, to allow working with data of both very small and very large values, the exponent may be offset by a bias, for example 127. The bias may be fixed at a different value to shift the exponent range to a range that has been previously determined from the data.

Implementations of the technology developed herein can work with lower-precision training data, for example in an 8-bit floating point format such as 1-4-3 (sign-exponent-fraction bits) or 1-5-2. To achieve this, the technology disclosed uses a dynamic bias rather than a fixed bias. This document teaches a method to dynamically change the bias during training, based on the maximum value of the tensor to be represented.

### Format Conversion for Training

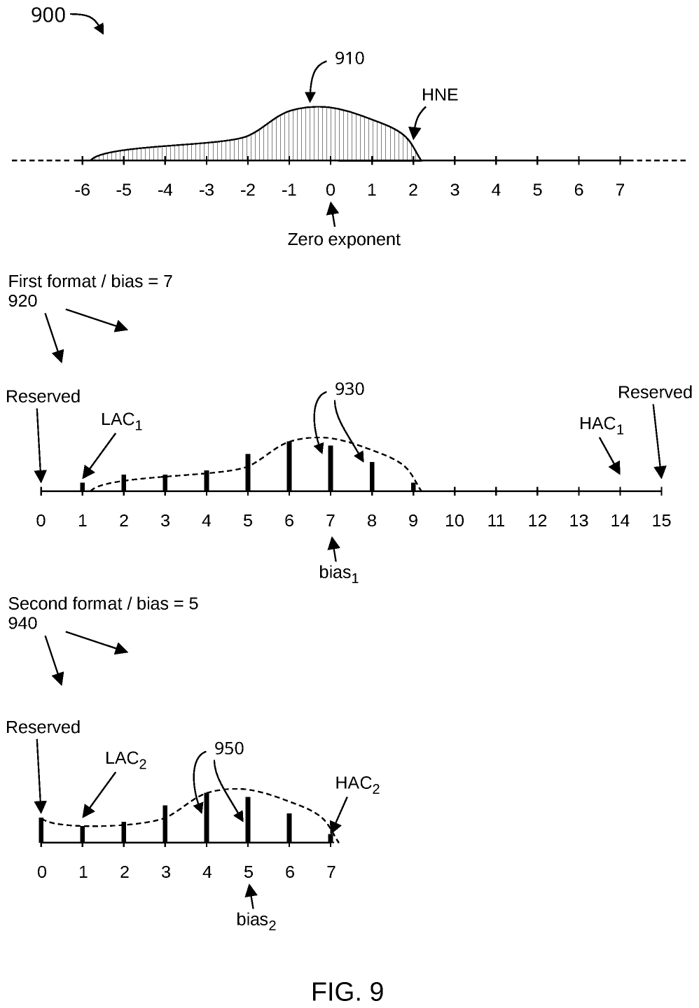

FIG. 9 illustrates how a tensor can be converted from a high-resolution format to a low-resolution format for training a neural network, in an implementation of the disclosed technology. The high-resolution format and the low-resolution format may be floating-point formats.

A floating-point format may be defined by a radix, a mantissa, an exponent, a bias, a lowest available code (LAC) and a highest available code (HAC). The radix depends on the numbering system, for example, radix=2 for binary digits or radix=10 for decimal digits. The mantissa is coded in a mantissa code, e.g., mantissa bits represent an unsigned integer or an unsigned fractional number, or as assumed in the examples below, a combination of an implied unsigned integer (always 1 for “normal” binary numbers or 0 for “subnormal” binary numbers or zero binary numbers) plus a fraction field (the only part that is shown). For the purpose of this document, the mantissa is left aligned, i.e., the most significant bit represents 2⁰=1 (the implied bit), so that the coded number has a mantissa field most significant bit whose value represents 2⁻¹=^{1/2}. For normal numbers, the exponent is coded in an exponent code between the LAC and the HAC. For subnormal numbers, the exponent equals the LAC, but the exponent code is a reserved code that indicates that the number is subnormal and that its implied bit equals 0. The exponent bias (bias) is an offset to the exponent code to allow both negative and positive exponents to be represented by a non-negative integer number. In some cases, the exponent code can have reserved codes, signifying that a number may be infinite, or that the data is not a number (NaN). A floating-point format may further have a sign, which may represent the value 1 or −1. The number encoded in the floating-point format equals for normal numbers:

$$number = sign * ( 1 + mantissa ) * {radix}^{code - bias} \qquad ( 1 )$$

and for subnormal numbers:

$$number = sign * mantissa * {radix}^{LAC - bias} \qquad ( 2 )$$

In some implementations, the high-resolution format (the first format) is IEEE 754 fp32 or bf16, including one sign bit, an eight-bit exponent code with a fixed bias of 127, and 23 mantissa bits (fp32) or seven mantissa bits (bf16). The low-resolution format (the second format) is a floating-point format with 12 or fewer bits, for example an 8-bit floating-point format such as 1-4-3 (sign-exponent-fraction bits) or 1-5-2. At least the low-resolution format supports subnormal numbers.

The exponent follows from the exponent code as follows:

$$exponent = code - bias \qquad ( 3 )$$

FIG. 9 shows an example distribution 900 of tensor values 910 on a logarithmic scale. The radix for the logarithmic scale may have a value of 2 for binary numbers, but other implementations may use any other radix. Distribution 900 shows that tensor values 910 have a minimum value just over 2⁻⁶ or 1/64 and a maximum value of slightly over 2², i.e., slightly over 4. Expressed as a floating-point number, the highest value of tensor values 910 has an exponent of 2, which for the tensor as a whole is the highest needed exponent (HNE). This assumes that the floating-point format is left aligned. If the tensor value with the highest exponent code codeₘₐₓ in the first format is known, then the HNE can be obtained with formula Error! Reference source not found. as follows:

$$HNE = {code}_{max} - {bias}_{1} \qquad ( 4 )$$

The distribution 920 shows how the tensor values 910 can be coded with (discrete) exponent codes 930 in a first floating-point format that has a code space of {1, . . . , 14} and where the codes 0 and 15 are reserved. In this floating-point format, the lowest available code (LAC₁) is 1 and the highest available code (HAC₁) is 14, and codes have a bias (bias₁) of 7.

The distribution 940 shows how tensor values 910 can be mapped to the second floating-point format, which has a dynamic bias. The second floating-point format has a much smaller exponent code space of {1, . . . , 7}, with a LAC₂ of 1 and a HAC₂ of 7. In this case, the second floating-point format reserves code 0 for subnormal numbers. The bias in the second floating-point format is not fixed, which allows mapping the HNE of distribution 900 onto HAC₂, so that the few bits that are available for the fraction are used much more efficiently. In this example, the bias becomes 5. Or, more generally:

$${bias}_{2} = {HAC}_{2} - HNE \qquad ( 5 )$$

Some implementations may limit the bias to unsigned integers, for example as follows:

$${bias}_{2} = Max ( {HAC}_{2} - HNE , 0 ) \qquad ( 6 )$$

Some of the lowest values in exponent codes 930 cannot be simply shifted into exponent codes 950 as they would result in values lower than LAC₂. Those exponent values need to use LAC₂. To compensate, the implementation must divide the mantissa by the radix or a power of the radix, as appropriate, and as further detailed below. In this example, exponents that in distribution 920 use codes 1 (i.e., LAC₁) and 2 are mapped onto LAC₂ of distribution 940. The conversion from the first format into the second format follows:

$${code}_{2} = Max ( {code}_{1} - {bias}_{1} + {bias}_{2} , {LAC}_{2} ) \qquad ( 7 )$$

$${code}_{2} = Max ( {code}_{1} - {bias}_{1} + {HAC}_{2} - HNE , {LAC}_{2} ) \qquad ( 8 )$$

If the first format and the second format both use mantissas that are left aligned, implementations may round (e.g., truncate) the mantissa in the first format to obtain a rounded mantissa that can be used to determine the mantissa in the second format:

$${rounded\_mantissa}_{1} = Round ( {mantissa}_{1} ) \qquad ( 9 )$$

The rounded mantissa is corrected to account for subnormal numbers where the exponent in the second format maps to LAC₂ for normal numbers:

$${mantissa}_{2} = {rounded\_mantissa}_{1} \qquad ( 10 )$$

and for subnormal numbers:

$${mantissa}_{2} = ( 1 + {rounded\_mantissa}_{1} ) * {radix}^{{code}_{1} - {code}_{2} - {bias}_{1} + {bias}_{2}} \qquad ( 11 )$$

For subnormal numbers, formula Error! Reference source not found. maps the exponent onto LAC₂, and formula Error! Reference source not found. shifts the rounded mantissa bits by the appropriate number of places.

Although the representation of the tensor values in the second floating-point format may lose some precision versus representation in the first floating-point format, the losses are limited because of the much more efficient use of the code space.

For clarity of explanation, the above example illustrates the conversion of tensor values of a rather small first format to an even smaller second format. However, the example is fully representative of conversions from more commonly used formats such as fp32 and bf16 to a variant of fp8.

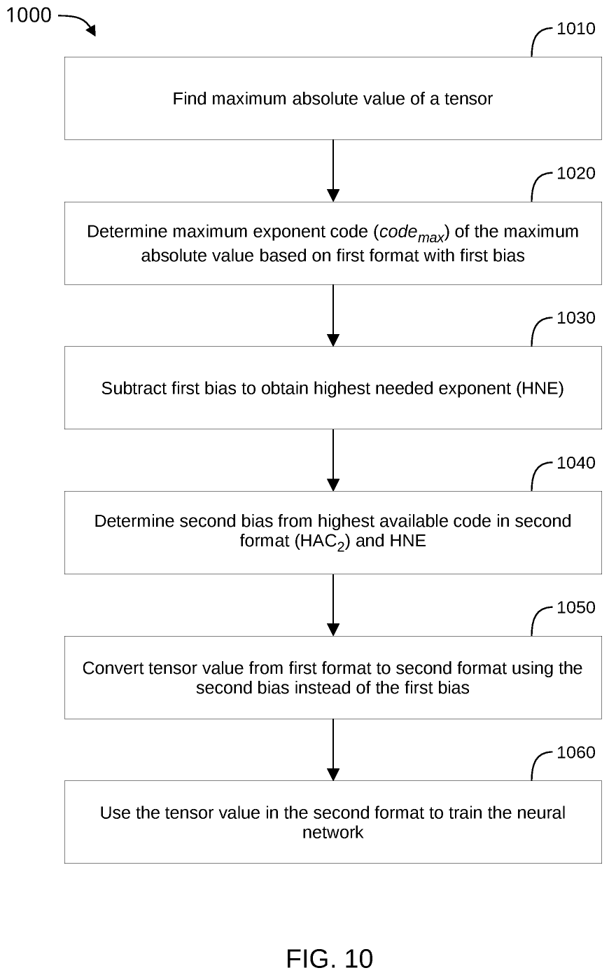

FIG. 10 shows an example method 1000 of converting a tensor value to train a neural network. A tensor used in training a neural network may include a large number of floating-point values. Often these values are defined in a first floating-point format with a relatively high resolution, such as bf16 or fp32. Method 1000 converts tensor values from the first format (with a first bias (bias₁)) to a low-resolution floating-point format (the second format) to enable more efficient training of the neural network. It is assumed that in both the first format and the second format the mantissa is left aligned, and that at least the second format supports subnormal numbers. Method 1000 comprises the following steps.

Step 1010—finding a maximum absolute value of a tensor. Based on their representation in the first format, the implementation determines the largest absolute value of the floating-point values that are included in the tensor. Step 1010 is optional, as some implementations may directly perform Step 1020.

Step 1020—determining a maximum exponent code (codeₘₐₓ) used in the tensor, based on the first format. Some implementations determine codeₘₐₓ from the exponent code of the first format representation of the maximum absolute value found in Step 1010.

Step 1030—subtracting the first bias (bias₁) from the maximum exponent code (codeₘₐₓ) to obtain the highest needed exponent (HNE). An implementation may use formula Error! Reference source not found. above to determine HNE.

Step 1040—determining a second bias (bias₂) from the highest available code (HAC₂) of the second format and HNE. The highest available code HAC₂ is fixed in the definition of the second format. An implementation may use formula Error! Reference source not found. or formula Error! Reference source not found. to determine the second bias.

Step 1050—converting a tensor value from the first format to the second format by using the second bias (bias₂) instead of the first bias (bias₁). An implementation may use the formulas Error! Reference source not found. through Error! Reference source not found. to convert the tensor value.

Step 1060—using the tensor value in the second format to train the neural network.

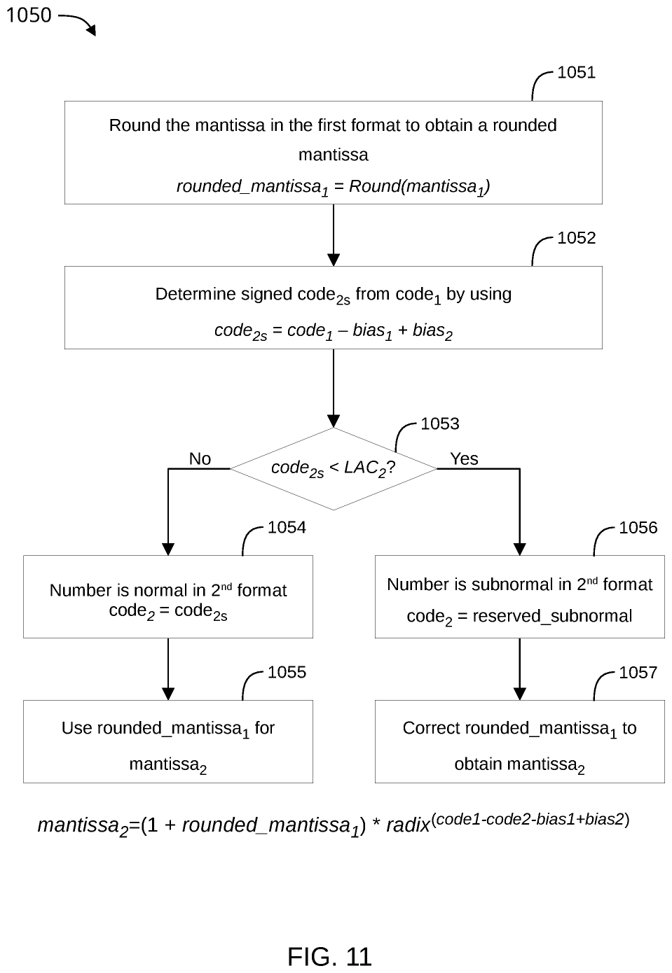

FIG. 11 illustrates example details of converting a tensor value from the first format to the second format. Step 1050 may include the following steps.

Step 1051—rounding the mantissa representing the tensor value in the first format (mantissa₁) to obtain a rounded mantissa (rounded_mantissa₁).

rounded_mantissa₁=Round(mantissa₁)

Step 1052—determining a signed code (code₂ₛ) from the first exponent code (code₁) representing an exponent of the tensor value in the first format by subtracting a first bias of the first format (bias₁) from the first exponent code and adding a second bias of the second format (bias₂).

$${code}_{2 s} = {code}_{1} - {bias}_{1} + {bias}_{2}$$

Step 1053—determining if the signed code is less than the lowest available code in the second format.

code₂ₛ<LAC₂?

Step 1054—upon determining that the signed code is not less than the lowest available code in the second format, using the signed code for the second exponent code (code₂) to represent the exponent of the tensor value in the second format. The number is normal in the second format. The method proceeds with Step 1055.

Step 1055—using the rounded mantissa (rounded_mantissa₁) for the mantissa that represents the tensor value in the second format (mantissa₂). The conversion may end here.

Step 1056—upon determining that the signed code is less than the lowest available code in the second format, using a reserved code that indicates a subnormal number for the second exponent code (code₂). The method proceeds with Step 1057.

code₂=reserved_subnormal

Step 1057—correcting the rounded mantissa to obtain the mantissa that represents the tensor value in the second format (mantissa₂). An implementation may correct the rounded mantissa by dividing the rounded mantissa by a power of the radix of the second format. An implementation may use formula (11) for Step 1057.

$${mantissa}_{2} = ( 1 + {rounded\_mantissa}_{1} ) * {radix}^{{code}_{1} - {code}_{2} - {bias}_{1} + {bias}_{2}}$$

### Considerations

We describe various implementations of a method used in training a neural network.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the implementations described herein.

Although the description has been described with respect to particular implementations thereof, these particular implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skills in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to particular implementations thereof, these particular implementations are merely illustrative, and not restrictive. For instance, many of the operations can be implemented in a CGRA system, a System-on-Chip (SoC), application-specific integrated circuit (ASIC), programmable processor, in a programmable logic device such as a field-programmable gate array (FPGA) or a graphics processing unit (GPU), obviating a need for at least part of the dedicated hardware. Implementations may be as a single chip, or as a multi-chip module (MCM) packaging multiple semiconductor dies in a single package. All such variations and modifications are to be considered within the ambit of the present disclosed technology the nature of which is to be determined from the foregoing description.

One or more implementations of the technology or elements thereof can be implemented in the form of a computer product, including a non-transitory computer-readable storage medium with computer usable program code for performing any indicated method steps and/or any configuration file for one or more CGR processors to execute a high-level program. Furthermore, one or more implementations of the technology or elements thereof can be implemented in the form of an apparatus including a memory and at least one processor that is coupled to the memory and operative to perform exemplary method steps, and/or a CGR processor that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit of the technology disclosed.

1. A method of converting a tensor value to train a neural network, comprising:
determining a maximum exponent code used in the tensor, based on a first format with a first bias;
subtracting the first bias from the maximum exponent code to obtain a highest needed exponent (HNE);
determining a second bias from a highest available code (HAC) in a second format and the HNE;
converting the tensor value from the first format to the second format by using the second bias instead of the first bias; and
using the tensor value in the second format to train the neural network.

2. The Error! Reference source not found. of claim Error! Reference source not found., wherein:
determining the maximum exponent code includes finding a maximum absolute value of the tensor.

3. The Error! Reference source not found. of claim Error! Reference source not found., wherein:
determining the second bias from the HAC and the HNE includes subtracting the HNE from the HAC.

4. The Error! Reference source not found. of claim Error! Reference source not found., wherein determining the second bias from the HAC and the HNE includes:
subtracting the HNE from the HAC to obtain a difference; and
selecting a maximum value of the difference and zero.

5. The Error! Reference source not found. of claim Error! Reference source not found., wherein:
the first format and the second format are floating-point formats, each including code bits for an exponent code, and mantissa bits for a mantissa code;
the exponent code is an integer;
the exponent code is based on an integer bias;
the mantissa code is left aligned and represents a fraction; and
the second format has twelve bits or fewer in total.

6. The Error! Reference source not found. of claim Error! Reference source not found., wherein converting the tensor value from the first format to the second format by using the second bias instead of the first bias includes:
rounding a mantissa of the tensor value in the first format to obtain a rounded mantissa of the tensor value;
determining a first exponent code of the exponent of the tensor value in the first format;
subtracting the first bias from the first exponent code and adding the second bias to obtain a signed code;
determining if the signed code is less than a lowest available code (LAC) in the second format;
upon determining that the signed code is not less than the LAC in the second format, using the signed code for the second exponent code and using the rounded mantissa for a second mantissa code; and
upon determining that the signed code is not less than the LAC in the second format, using a reserved code for the second exponent code and correcting the rounded mantissa to obtain the second mantissa code.

7. The Error! Reference source not found. of claim Error! Reference source not found., wherein:
the neural network is included in one of a coarse-grained reconfigurable (CGR) processor, a graphics processing unit (GPU), a field-programmable array (FPGA), a central-processing unit (CPU), and an application-specific integrated circuit (ASIC).

8. A non-transitory computer-readable storage medium storing computer program instructions to convert a tensor value to train a neural network, wherein the computer program instructions, when executed on a processor, implement actions comprising:
determine a maximum exponent code used in the tensor, based on a first format with a first bias;
subtract the first bias from the maximum exponent code to obtain a highest needed exponent (HNE);
determine a second bias from a highest available code (HAC) in a second format and the HNE;
convert the tensor value from the first format to the second format by using the second bias instead of the first bias; and
use the tensor value in the second format to train the neural network.

9. A system including one or more processors coupled to a memory, the memory loaded with computer program instructions to convert a tensor value to train a neural network, wherein the computer program instructions, when executed on the one or more processors, implement actions comprising:
determine a maximum exponent code used in the tensor, based on a first format with a first bias;
subtract the first bias from the maximum exponent code to obtain a highest needed exponent (HNE);
determine a second bias from a highest available code (HAC) in a second format and the HNE;
convert the tensor value from the first format to the second format by using the second bias instead of the first bias; and
use the tensor value in the second format to train the neural network.
